(19) United States
(12) Patent Application Publication
(10) Pub. No.: US 2026/0312709 A1
(43) Pub. Date: Oct. 8, 2026

(54) DYNAMIC BROADCAST ISOCHRONOUS GROUP CONFIGURATION MODIFICATION BASED ON MEDIA STATE

(71) Applicant: GOOGLE LLC, Mountain View, CA (US)

(72) Inventors: Praveen Kumar Rayasamudra Vijayakumar, Sunnyvale, CA (US); Qi Jiang, San Jose, CA (US); Li-Xuan Chuo, SanJose, CA (US)

(21) Appl. No.: 19/098,584

(22) Filed: Apr. 2, 2025

(51) Int. Cl. H04H 20/86; H04H 20/10; H04H 20/18

(52) U.S. Cl. CPC H04H 20/86; H04H 20/106; H04H 20/18

(57) ABSTRACT

A user equipment (UE) broadcasts an audio stream such that the audio stream is receivable by the receiver devices in a broadcast isochronous group (BIG). While broadcasting this audio stream, the UE broadcasts packets of the audio stream as a series of broadcast events as defined by BIG configuration data store on the UE. In response to determining that the audio stream is to enter a pause state, the UE modifies the BIG configuration data at the UE to reduce the number of broadcasts during a broadcast event. The UE then begins broadcasting null data based on the updated BIG configuration data, allowing the receiver devices in the BIG to remain synchronized with the audio stream.

### BACKGROUND

Some user equipment (UE) are configured to concurrently provide an audio stream to two or more receiver devices, such as earbuds, headphones, speakers, and the like, by broadcasting packets of the audio stream on one or more isochronous channels. After being broadcast by the UE, the packets of the audio stream are receivable by any number of receiver devices within the broadcast range. To synchronize the reception of the broadcast by the receiver devices, the UE is configured to broadcast the audio stream as a series of broadcast events that each include a number of subevents. Further, each broadcast event includes an anchor point representing the beginning of the broadcast event and a synchronization point that is a predetermined period of time after the anchor point that serves as a timing reference for synchronizing the reception of the audio stream by the receiver devices.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a block diagram of a user equipment (UE) configured to dynamically adjust the broadcast isochronous group (BIG) configuration data for a broadcast isochronous stream (BIS) based on a media state, in accordance with embodiments.

FIG. 2 is a flow diagram of an example operation for dynamically adjusting the BIG configuration data at a UE broadcasting an audio stream based on a media state, in accordance with embodiments.

FIG. 3 is a block diagram of a UE configured to dynamically adjust the BIG configuration data of one or more receiver devices subscribed to an audio stream broadcast by the UE, in accordance with embodiments.

FIG. 4 is a flow diagram of an example method for dynamically adjusting the BIG configuration data of one or more receiver devices subscribed to an audio stream broadcast by an UE, in accordance with embodiments.

### DETAILED DESCRIPTION

Systems and techniques disclosed herein include user equipment (UE), such as compute-enabled phones (i.e., smartphones), tablet computers, personal computers, compute-enabled wearable devices, Internet of Things (IoT) devices, laptop computer, routers, mobile hotspot devices, automotive devices, manufacturing devices, and the like, configured to broadcast an audio stream such that multiple receiver devices within the range of the broadcast receive the audio stream. To broadcast the audio stream, a UE uses one or more isochronous channels to broadcast packets of the audio stream based on one or more certain communication protocols, for example, Bluetooth® Low Energy communication protocol (Bluetooth LE), so that the packets of the audio stream are receivable within a certain range (e.g., the distance from the UE at which packets broadcast by the UE are receivable by a receiver device). In response to receiving one or more packets of the audio stream broadcast by the UE, a receiver device is configured to output the audio in the received packets. Such receiver devices, for example, include portable devices having one or more output devices (e.g., speakers) such as wireless headphones, wireless earbuds, wireless in-ear monitors, wireless over-ear headphones, wireless on-ear headphones, bone-conduction headphones, wireless speakers, wireless hearing aids, and the like. Receiver devices receiving packets of the audio stream broadcast by the UE (e.g., receiver devices subscribed to the audio stream) are also referred to herein as a broadcast isochronous group (BIG).

The UE is configured to broadcast packets of the audio stream to the BIG as a series of broadcast isochronous stream (BIS) events that each include the broadcast of one or more packets of the audio stream. Further, each BIS event of the broadcast includes one or more parameters (e.g., BIG configuration parameters) as defined by BIG configuration data that indicates, for example, the number of subevents in a BIS event, a burst number (BN) parameter indicating the number of data units (e.g., protocol data units) that may be scheduled for broadcast and rebroadcast (e.g., the number of data units in a burst), a group count parameter indicating an organization of the subevents, an immediate representation count (IRC) parameter indicating how many times a burst of data units is rebroadcast in the subevents of the BIS event, a pre-transmission offset (PTO) parameter indicating an offset of future BIS events that have data rebroadcast in the current BIS event, a delay parameter indicating a period of time between an anchor point and a synchronization point of the BIS event, or any combination thereof. Using the BIG configuration data, the UE broadcasts one or more packets of the audio stream during a first BIS event that includes multiple subevents during which the UE broadcasts one or more data units for the packets of the audio stream, a control data unit indicating control data for the audio stream, or both. The UE then broadcasts one or more additional packets of the audio stream during a second BIS event also including one or more data units for the additional packets of the audio stream, a control data unit indicating control data for the audio stream, or both.

To help synchronize the reception of packets of the audio stream by the receiver devices of the BIG, the BIS events of the UE include an anchor point (e.g., first subevent) indicating the beginning of a BIS event and a synchronization point (e.g., last non-control subevent) a period of time away from the anchor point that represents a reference timing point for the receiver devices of the BIG. As used herein, this period of time between the anchor point and synchronization point of a BIS even is referred to as a “synchronization delay” and is defined by the BIG configuration data. Each receiver in the BIG also includes the BIG configuration data defining the BIS events of the UE. In response to receiving a subevent indicating the synchronization point, a receiver device begins processing the received audio data and outputs the audio data after a period of time (e.g., presentation delay) from the synchronization point as defined by the BIG configuration data at the receiver devices. However, when the state of the audio stream at the UE changes from play to pause, the UE must continue broadcasting data during BIS events as defined by the BIG configuration data in order to keep the receiver devices of the BIG synchronized. For example, the UE broadcasts null data units during BIS events as defined by the BIG configuration data to keep the receiver devices synchronized. However, broadcasting the null data units in this way increases the number of broadcasts by the UE and does not decrease the amount of power consumed by the UE when the audio stream is paused.

As such, the UE is configured to dynamically change the BIG configuration data at the UE, receiver devices in the BIG, or both based on the state of the audio stream. For example, in response to the state of the media change changing from play (e.g., play music) to pause (e.g., pause play of music), the UE determines one or more predetermined values for one or more BIG configuration parameters based on the media being in a pause state. That is to say, the UE identifies the predetermined values for corresponding BIG configuration parameters that are associated with a pause state. The UE then modifies the BIG configuration data based on identified predetermined values. As an example, the UE modifies the BIG configuration data such that the BIG configuration data defines a broadcast event as including two subevents (e.g., only an anchor point and a synchronization point) where a burst of two data units is broadcast. The UE then begins to broadcast null data (e.g., null data units) based on the modified BIG configuration data. In this way, the UE is enabled to reduce the number of non-control subevents in a BIS event to only an anchor point subevent and a synchronization point subevent which conserves power at the UE. Additionally, because an event of the modified BIG configuration data at the UE still includes an anchor point and synchronization point with the same delay as the non-modified BIG configuration data, the receiver devices are able to stay synchronized with the audio stream without modifying their own BIG configuration data. In response to the audio stream again being in a play state, the UE again modifies the BIG configuration data based on predetermined values of BIG configuration parameters associated with the play state and then broadcasts packets of the audio stream using the modified BIG configuration data.

As another example, in response to the state of the media change changing from play (e.g., play music) to pause (e.g., pause play of music), the UE modifies the BIG configuration data such that the BIG configuration data defines a broadcast event as including a minimum number of non-control subevents (e.g., one non-control subevent) where a burst of two data units are broadcast. The UE then begins broadcasting an update packet indicating the updated BIG configuration data. In response to receiving the broadcast update packet, each receiver device in the BIG modifies its BIG configuration data based on the received update packet (e.g., modified to match the modified BIG configuration data indicated in the update packet). Further, the UE begins broadcasting data units in broadcast events that include a single non-control subevent (e.g., one non-control subevent). Due to the number of subevents in a broadcast event being reduced to 1, the UE conserves power when the audio stream is in a pause state. Further, because the BIG configuration data was updated at the receiver devices in the BIG due to the update packet, the receiver devices remain synchronized with the paused audio stream. In response to the audio stream again being in a play state, the UE modifies the BIG configuration data based on predetermined values of parameters associated with the play state and broadcasts another update packet to the receiver devices in the BIG reflecting these modifications. The UE then broadcasts packets of the audio stream using the modified BIG configuration.

As used herein, the term “circuitry” includes hardwired circuitry, programmable circuitry, or a combination thereof. For example, circuitry may include circuitry of an application-specific integrated circuit (ASIC) that is hardwired or hardcoded to perform corresponding functions, one or more processors that execute software stored in one or more memories or other storage media to perform corresponding functions, programmable logic that has been programmed to perform corresponding functions, or some combination thereof.

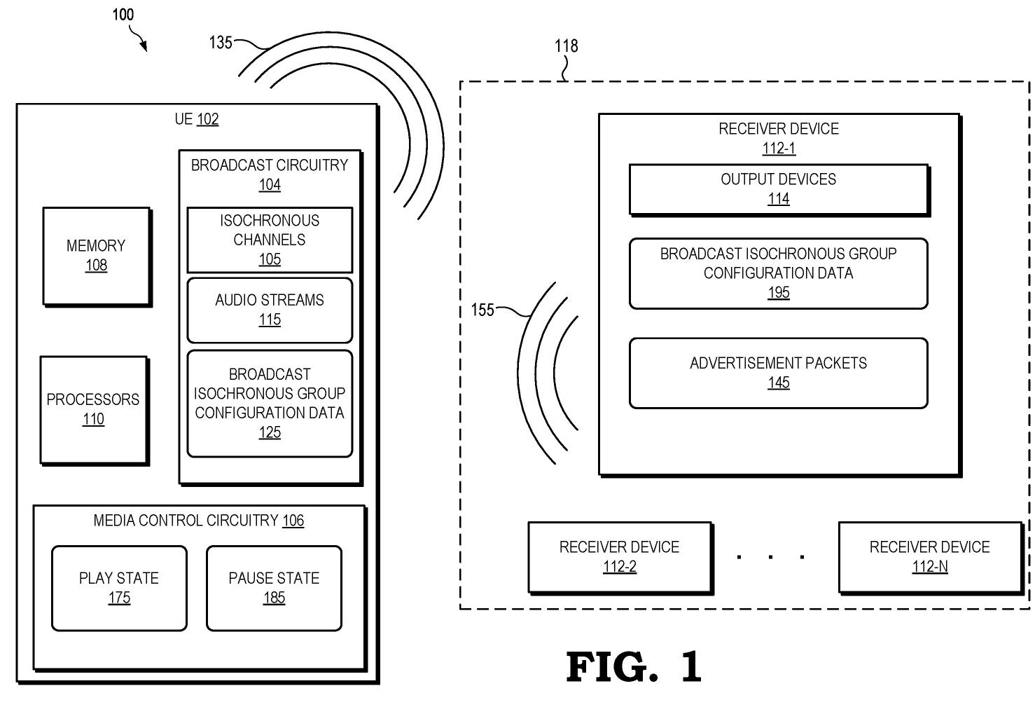

Referring now to FIG. 1, a block diagram of a UE broadcast framework 100 configured to adjust an antenna tuning profile based on advertisement packets from one or more receiver devices is presented, in accordance with some embodiments. In embodiments, UE broadcast framework 100 includes UE 102 configured to broadcast an audio stream 115 such that one or more packets of the broadcast audio stream (represented in FIG. 1 as broadcast audio stream 135) are received by one or more receiver devices 112 within the range of the broadcast (e.g., the distance from UE in which one or more packets of the broadcast audio stream 135 are receivable). UE 102, for example, includes a smartphone, tablet computer, personal computer, laptop computer, compute-enabled wearable device (e.g., smartwatch, fitness tracker, smart bracelet), IoT device, router, mobile hotspot device, an automotive device, a manufacturing device, or any combination thereof, to name a few. Additionally, an audio stream 115 includes one or more packets that include data representing audio to be output by one or more receiver devices 112.

To broadcast an audio stream 115, UE 102 includes broadcast circuitry 104 configured to broadcast one or more packets of the audio stream 115 using one or more isochronous channels 105 (e.g., broadcast isochronous channels). As an example, broadcast circuitry 104 includes one or more isochronous channels 105 over which broadcast circuitry 104 broadcasts packets of an audio stream 115 based on one or more communication protocols (e.g., a Bluetooth low energy communication protocol). An isochronous channel 105 is configured to broadcast one or packets of an audio stream 115 using a corresponding range of frequencies (e.g., 2MHz range of frequencies) such that the broadcast packets are receivable by receiver devices 112 within the range of the broadcast. In embodiments, a receiver device 112 configured to receive a broadcast audio stream 115 includes, for example, a portable device configured to receive packets of a broadcast audio stream 135 using one or more communication protocols (e.g., Bluetooth LE) and to output audio represented by the received packets. For example, a receiver device 112 includes one or more wireless headphones, wireless earbuds, wireless in-ear monitors, wireless over-ear headphones, wireless on-ear headphones, bone-conduction headphones, wireless speakers, wireless hearing aids, and the like. In some embodiments, a receiver device 112 includes a paired device (e.g., one device of a pair of devices), such as one earbud of a pair of earbuds, while in other embodiments, a receiver device includes a singular device such as headphones. In response to receiving one or more packets of a broadcast audio stream 135, a receiver device 112 is configured to output the audio represented by the received packets using one or output devices 114 that include, for example, speakers, audio monitors, or the like.

As used herein, the receiver devices 112 receiving at least a portions of the broadcast audio stream 135 (e.g., the receiver devices 112 subscribed to the audio stream 135) is referred to as a BIG 118. Though the example embodiment presented in FIG. 1 shows the BIG 118 as including three receiver devices (112-1, 112-2, 112-N) representing an N integer number (where N>0) of receiver devices, in other embodiments, the BIG 118 can include any non-zero integer number of receiver devices receiving at least a portion of broadcast audio stream 135. To help ensure that output of the audio stream 115 is synchronized across the receiver devices 112 in the BIG 118, UE 102 is configured to broadcast packets of the audio stream 115 as a series of BIS events during which broadcast circuitry 104 broadcasts one or more data units (e.g., protocol data units) representing one or more packets of audio stream 115, control data (e.g., channel map updates, BIG termination details), or both. These broadcast events performed by UE 102 are defined by BIG configuration data 125 (e.g., defined by broadcast isochronous group configuration data) stored, for example, in memory 108. This BIG configuration data 125 includes values that define one or more parameters (e.g., BIG configuration parameters) of the broadcast events such as the number of subevents in a BIS event, a BN parameter indicating the number of data units in a burst (e.g., the number of data units to be broadcast during a broadcast event), a group count parameter indicating an organization of the subevents of the BIS events, an IRC parameter indicating how many times a burst of data units is rebroadcast in the subevents of the BIS event, a PTO parameter indicating an offset of future BIS events that have data rebroadcast in the current BIS event, a delay parameter indicating a period of time between an anchor point and a synchronization point of the BIS event, or any combination thereof. Further, each broadcast event performed by UE 102 includes an anchor point representing the first subevent of the broadcast event and a synchronization representing the last non-control subevent of the broadcast that is a period of time (e.g., synchronization delay) away from the anchor point as indicated by a delay parameters of the BIG configuration data 125.

In embodiments, the synchronization point of a broadcast event acts as a timing reference to synchronize the output of the audio stream 115 by the receiver devices 112 in the BIG 118. For example, each receiver device 112 in the BIG 118 is configured to store BIG configuration data 195 indicating the parameters of the broadcast events for the audio stream 115. In response to receiving a data unit indicating the synchronization point of a broadcast event, a receiver device 112 begins processing the data received during the broadcast event and outputs audio from the processed data a predetermined amount of time after the synchronization point as indicated by the BIG configuration data 195. Additionally, according to some embodiments, in response to receiving one or more data units during one or more broadcast events of the audio stream 115, one more receiver devices 112 are configured to periodically (e.g., every 500 milliseconds, every one second) broadcast one or more advertisement packets 145 including link status data in response to receiving one or more packets of broadcast audio stream 135. This link status data indicates the strength of the link between the receiver device 112 and UE 102 (e.g., the UE 102 that broadcasts the audio stream 115. For example, link status data includes a PER for the receiver device 112 over a predetermined period of time (e.g., the period of time between broadcasts of advertisement packets 145), the number of times the receiver device 112 was out of sync with the broadcast audio stream 135 over a predetermined period of time, or any combination thereof, to name a few. An advertisement packet 145 broadcast by a receiver device is represented in FIG. 1 as a broadcast advertisement packet 155.

In embodiments, UE 102 includes media control circuitry 106 configured to receive one or more inputs from a user such as interactions with a touchscreen, gestures on a touchscreen, captured speech, captured sounds, button presses, move of UE 102, or the like. From one or more received inputs, media control circuitry 106 determines a media state for the audio stream 115 such as a play state 175 during which UE 102 broadcasts audio stream 115 for output on the receiver devices 112 of the BIG 118 and a pause state 185 during which UE 102 pauses the broadcast of audio stream 115 for output on the receiver devices 112 of the BIG 118. Further, according to embodiments, UE 102 is configured to dynamically adjust one or more parameters of the BIG configuration data 125 stored at UE 102, the BIG configuration data 195 stored at one or more receiver devices 112 of the BIG 118, or both based on the current media state of the audio stream 115. As an example, in some embodiments, in response to audio stream 115 being in a pause state 185 (e.g., in response to media control circuitry 106 determining audio stream 115 is to be in a pause state 185), broadcast circuitry 104 determines one or more predetermined values for one or more BIG configuration parameters that are associated with a pause state 185. Broadcast circuitry 104 then modifies the BIG configuration data 125 stored at UE 102 based on the determined predetermined values for one or more BIG configuration parameters that are associated with a pause state 185. For example, broadcast circuitry 104 modifies BIG configuration data 125 such that a broadcast event is defined as having only two non-control subevents over which two data units (e.g., null data units) are to be broadcast with a first subevent representing an anchor point and a second subevent representing a synchronization point. In an example embodiment, broadcast circuitry 104 modifies BIG configuration data 125 such so as to define a broadcast event as having two non-control subevents, a burst number of two (e.g., two data units to be broadcast in a broadcast event), a PTO parameter of zero, an IRC parameter of zero, and a delay parameter of 8.566 milliseconds. After broadcast circuitry 104 modifies the BIG configuration data 125, broadcast circuitry 104 broadcasts null data (e.g., null data units) according to the updated BIG configuration data 125. For example, for each broadcast event, broadcast circuitry 104 broadcasts a first null data unit at an anchor point of the broadcast event and a second null data unit at the synchronization point of the broadcast event that is a period of time after the anchor point as defined by the updated BIG configuration data 125.

In this way, the UE 102 is enabled to broadcast null data in broadcasting events that include an anchor point and synchronization point a period of time after the anchor point that is in line with the BIG configuration data 195 of the receiver devices 112 in the BIG, which allows the receiver devices 112 to remain synchronized with the audio stream 115. Further, in response to the audio stream 115 returning to a play state 175 (e.g., in response to the media control circuitry 106 determining that the audio stream 115 is to be in a play state 175), UE 102 determines one or more predetermined values for one or more BIG configuration parameters that are associated with a play state 175 and modifies the BIG configuration data 125 stored at UE 102 based on the determined predetermined values. As an example, UE 102 modifies BIG configuration data 125 so as to increase the number of subevents in a broadcast event, the burst number of a broadcast event, or both such that one or more packets of the audio stream 115 are broadcast by UE 102 during a broadcast event.

As another example, in embodiments, in response to audio stream 115 being in a pause state 185 (e.g., in response to media control circuitry 106 determining audio stream 115 is to be in a pause state 185), broadcast circuitry 104 determines one or more predetermined values for one or more BIG configuration parameters that are associated with a pause state 185. Broadcast circuitry 104 then modifies the BIG configuration data 125 stored at UE 102 based on the determined predetermined values for one or more BIG configuration parameters that are associated with a pause state 185. For example, broadcast circuitry 104 modifies BIG configuration data 125 such that a broadcast event is defined as having only one non-control subevent over which a data unit (e.g., null data unit) is to be broadcast. After modifying the BIG configuration data 125, broadcast circuitry 104 begins periodically (e.g., every 500 milliseconds, 1 second) broadcasting an update packet that includes configuration update data reflecting the modifications to the BIG configuration data 125 (e.g., one or more values for parameters of the modified BIG configuration data 125) such that the broadcast update packet is receivable by the receiver devices 112 in the BIG 118. In response to receiving the broadcast update packet, a receiver device modifies the BIG configuration data 195 stored at the receiver device 112 based on the configuration update data in the update packet. As an example, the receiver device modifies the BIG configuration data 195 to match the values for BIG configuration parameters indicated in the update packet. Further, after modifying the BIG configuration data 125, broadcast circuitry 104 begins broadcasting data (e.g., null data) based on the modified BIG configuration data 125. For example, broadcast circuitry 104 broadcasts a null data unit during the sole non-control subevent of a broadcast event.

Due to the BIG configuration data 195 of the receiver devices 112 in the BIG 118 being updated to match the modified BIG configuration data 125 of the UE 102, the receiver devices 112 in the BIG 118 are able to stay synchronized with the audio stream 115 when UE 102 beings broadcasting null data units based on the modified BIG configuration data 125. Additionally, in response to the audio stream 115 returning to a play state 175 (e.g., in response to the media control circuitry 106 determining that the audio stream 115 is to be in a play state 175), UE 102 determines one or more predetermined values for one or more BIG configuration parameters that are associated with a play state 175 and modifies the BIG configuration data 125 stored at UE 102 based on the predetermined values. As an example, UE 102 modifies BIG configuration data 125 so as to increase the number of subevents in a broadcast event, the burst number of a broadcast event, or both such that one or more packets of the audio stream 115 are broadcast by UE 102 during a broadcast event. Further, UE 102 then begins periodically broadcasting another update packet that includes configuration update data reflecting these changes to the BIG configuration data 125. In response to receiving this update packet, a receiver device 112 in the BIG 118 updates its BIG configuration data 195 based on the configuration update data in the update packet. Additionally, UE 102 then broadcasts packets of the audio stream 115 during broadcast events as defined by the updated BIG configuration data 125.

In embodiments, UE 102 includes a memory 108 that includes a storage, random-access memory (RAM) (e.g., static RAM, dynamic RAM), or both storing executable instructions, data, or both used by broadcast circuitry 104, media control circuitry 106, or both to broadcast one or more audio streams 115 based on BIG configuration data 125, detect the media state of an audio stream 115, update BIG configuration data 125, or any combination thereof, to name a few. Further, in some embodiments, memory 108 stores executable instructions that, when executed by one or more processors 110 (e.g., central processing units, graphics processing units, microprocessors) of UE 102, cause the processors 110 to broadcast one or more audio streams 115 based on BIG configuration data 125, detect the media state of an audio stream 115, update BIG configuration data 125, or any combination thereof, to name a few. Additionally, one or more processors 110, in some embodiments, implement at least a portion of broadcast circuitry 104, media control circuitry 106, or both.

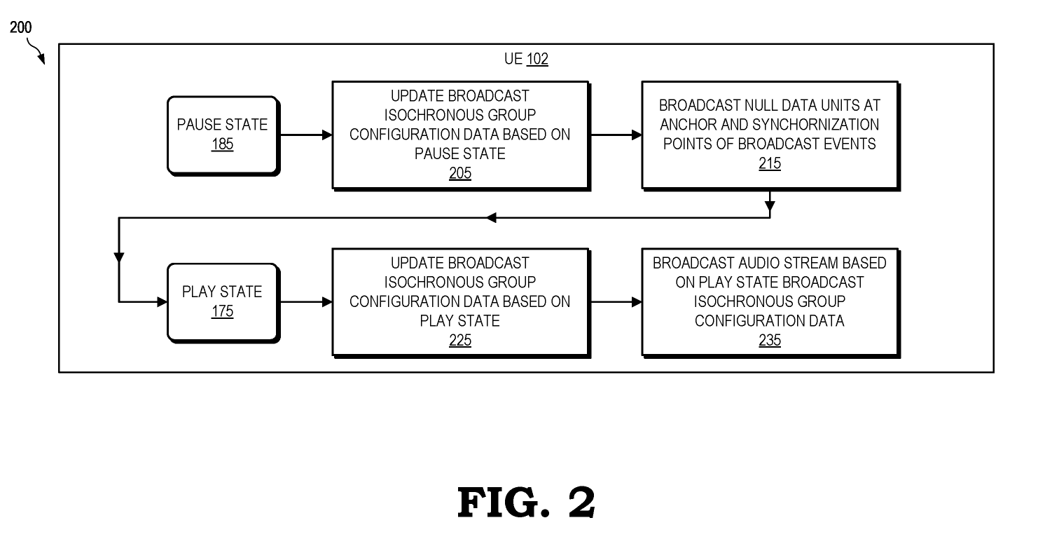

Referring now to FIG. 2, an example operation 200 for dynamically adjusting the BIG configuration data at a UE broadcasting an audio stream is presented, in accordance with embodiments. In embodiments, at least a portion of example operation 200 is implemented by UE 102. For example, at block 205 of example operation 200, media control circuitry 106 of UE 102 receives one or more inputs indicating that the media state of the audio stream 115 is to be a pause state 185 and switches audio stream 115 to a pause state 185. In response to audio stream 115 switching to a pause state 185, broadcast circuitry 104 determines one or more predetermined values for corresponding BIG configuration parameters that are associated with a pause state 185. For example, broadcast circuitry 104 searches memory 108 for predetermined values for corresponding BIG configuration parameters that are associated with a pause state 185. Using these predetermined values of BIG configuration parameters, broadcast circuitry 104 updates the BIG configuration data 125. As an example, broadcast circuitry 104 updates BIG configuration data 125 to define a broadcast event as having 2 subevents and a burst number of 2 (e.g., 2 data units are to be broadcast during the event). After updating the BIG configuration data 125 based on the predetermined values for BIG configuration parameters associated with the pause state 185, at block 215, broadcast circuitry 104 begins broadcasting null data units over broadcast events as defined by the updated BIG configuration data 125. For example, during a broadcast event defined by the updated BIG configuration data 125, broadcast circuitry 104 broadcasts one or more null data units during a first subevent (e.g., anchor point) and one or more additional null data units during a second subevent (e.g., synchronization point) a period of time after the first subevent as indicated by the updated BIG configuration data 125.

At block 225, media control circuitry 106 of UE 102 receives one or more inputs indicating that the media state of the audio stream 115 is to be a play state 175 and switches audio stream 115 to a play state 175. In response to audio stream 115 switching to a play state 175, broadcast circuitry 104 determines one or more predetermined values for corresponding BIG configuration parameters that are associated with a play state 175. As an example, broadcast circuitry 104 searches memory 108 for predetermined values for corresponding BIG configuration parameters that are associated with a play state 175. Broadcast circuitry 104 then updates the BIG configuration data 125 based on the predetermined values of the BIG configuration parameters. For example, broadcast circuitry 104 updates BIG configuration data 125 to increase the number of subevents, the burst number, or both of a broadcast event such that one or more packets of the audio stream 115 are broadcast during each broadcast event. At block 235, broadcast circuitry 104 begins broadcasting packets of the audio stream 115 as a series of broadcast events as defined by the updated BIG configuration data 125.

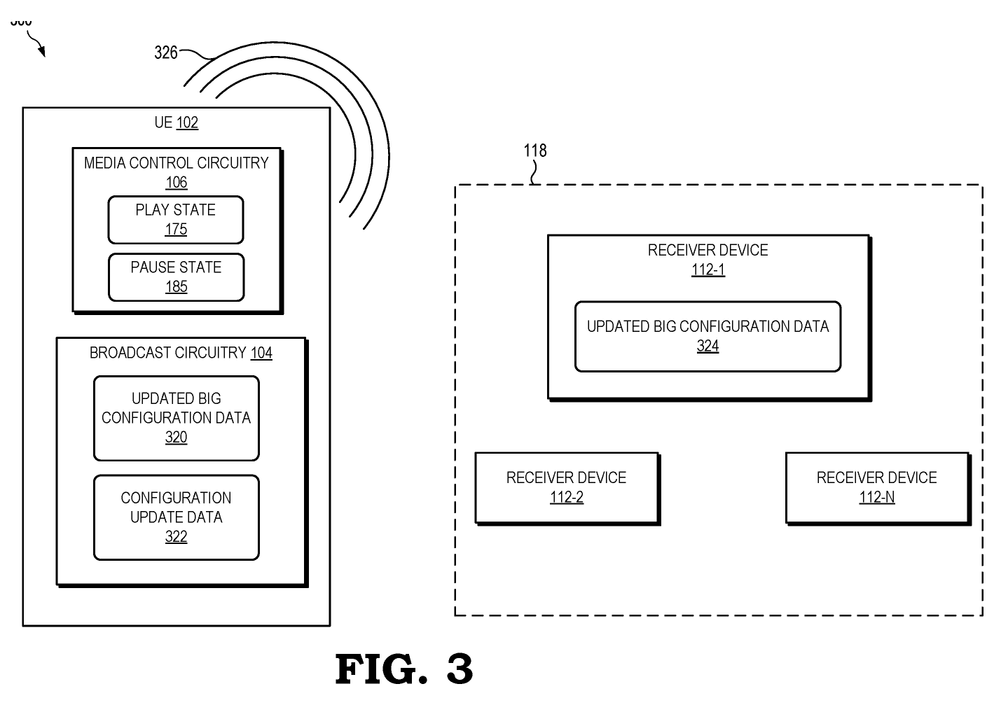

Referring now to FIG. 3, a block diagram of a system 300 including a UE configured to dynamically adjust the BIG configuration data of one or more receiver devices subscribed to an audio stream broadcast by the UE is presented, in accordance with embodiments. In embodiments, when audio stream 115 is in a play state 175, broadcast circuitry 104 is configured to broadcast one or more packets of audio stream 115 as a series of broadcast events defined by BIG configuration data 125. Concurrently with UE broadcasting one or more packets of audio stream 115, media control circuitry 106 is configured to receive one or more inputs that indicate the audio stream 115 is to enter a pause state 185 and pauses the audio stream 115 (e.g., places the audio stream 115 in a pause state 185). In response to audio stream 115 entering a pause state 185, broadcast circuitry 104 is configured to identify one or more predetermined values for BIG configuration parameters that are associated with a pause state 185 (e.g., by searching memory 106). Broadcast circuitry 104 then modifies BIG configuration data 125 based on (e.g., to match) these predetermined values to produce updated BIG configuration data 320. As an example, broadcast circuitry 104 modifies BIG configuration data 125 to produce updated BIG configuration data 320 that defines a broadcast event as having a single subevent (e.g., one non-control subevent) during which one or more data units are broadcast. After producing updated BIG configuration data 320, broadcast circuitry 104 begins periodically broadcasting an update packet that includes configuration update data 322 that indicates the updated BIG configuration data 320 (e.g., indicates the values of parameters in the updated BIG configuration data 320). In embodiments, broadcast circuitry 104 broadcasts this update packet such that a broadcasted update packet 326 is receivable by each receiver device 112 in the BIG 118.

In response to receiving the broadcast update packet 326, a receiver device 112 in the BIG 118 updates the BIG configuration data 195 stored at the receiver device 112 based on the configuration update data 322 indicated in the broadcast update packet 326 so as to produce updated BIG configuration data 324. As an example, the receiver device 112 updates the BIG configuration data 195 to match the values of parameters indicated in the configuration update data 322 of the broadcast update packet 326. Further, after broadcasting one or more update packets, broadcast circuitry 104 begins broadcasting data (e.g., null data) as a series of broadcast events as defined by the updated BIG configuration data 320. For example, broadcast circuitry 104 broadcasts one or more null data units during a single subevent for each broadcast event. According to embodiments, concurrently with broadcasting this data according to the updated BIG configuration data 320, media control circuitry 106 receives one or more inputs that indicate the audio stream is to again enter a play state 175 and switches the audio stream 115 to a play state.

In response to the audio stream being in a play state 175, broadcast circuitry 104 identifies one or more predetermined values for BIG configuration parameters that are associated with a play state 175. As an example, broadcast circuitry 104 searches memory 108 for one or more predetermined values of BIG configuration parameters associated with the play state 175. Broadcast circuitry 104 then modifies updated BIG configuration data 320 based on (e.g., to match) the identified predetermined values. For example, broadcast circuitry 104 modifies updated BIG configuration data 320 so as to increase the number of subevents, the burst number, or both of broadcast events such that one or more packets of the audio stream 115 are broadcast during each broadcast event. After modifying the updated BIG configuration data 320, broadcast circuitry 104 begins periodically broadcasting one or more additional update packets that include data reflecting these changes to the updated BIG configuration data 320 (e.g., reflecting the values of parameters in the updated BIG configuration data 320 as modified based on the play state 175). In response to receiving one of the additional update packets, a receiver device 112 in the BIG 118 modifies its updated BIG configuration data based on the data in the additional update packet (e.g., to match the values for parameters indicated in the additional update packet). Further, after broadcasting one or more additional update packets, broadcast circuitry 104 begins broadcasting one or more additional packets of the audio stream 115 as a series of broadcast events as defined by the modified updated BIG configuration data 320.

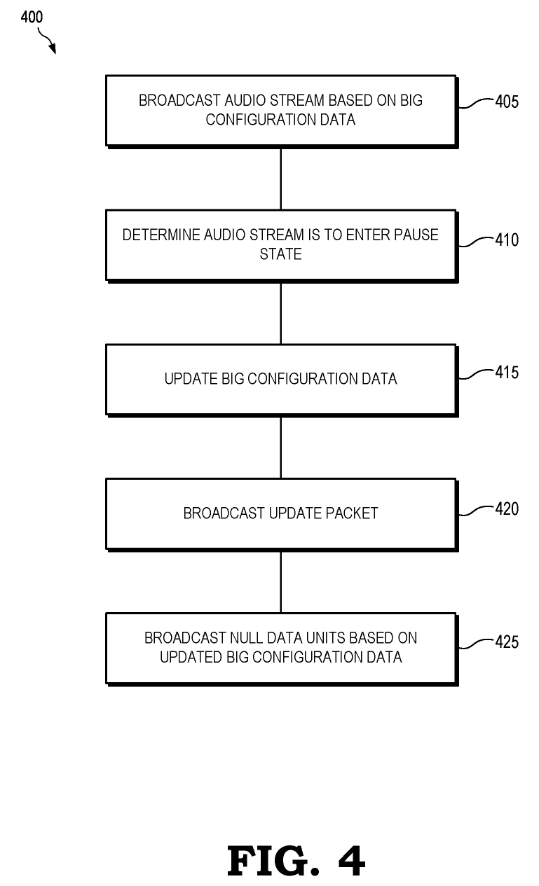

Referring now to FIG. 4, an example method 400 for dynamically adjusting the BIG configuration data of one or more receiver devices subscribed to an audio stream broadcast by an UE, in accordance with embodiments. In embodiments, example method 400 is implemented by UE 102 (e.g., broadcast circuitry 104, media control circuitry 106). Example method 400 includes, at block 405, UE 102 broadcasting one or more packets of an audio stream 115 as a series of broadcast events that are defined by BIG configuration data 125. During a broadcast event, as an example, UE 102 broadcasts one or more data units representing one or more packets of audio stream 115 over one or more subevents based on the BIG configuration parameters indicated by BIG configuration data 125. Concurrently with UE 102 broadcasting packets of the audio stream 115, at block 410, UE 102 determines that the audio stream 115 is to enter a pause state 185. As an example, UE 102 receives one or more inputs indicating that the audio stream 115 is to enter the pause state 185. In response to determining that the audio stream 115 is to be in a pause state 185, at block 415, UE 102 determines one or more predetermined values for corresponding BIG configuration parameters that are associated with a pause state 185. For example, broadcast circuitry 104 searches memory 108 for predetermined values for corresponding BIG configuration parameters that are associated with a pause state 185. Using these predetermined values of parameters, broadcast circuitry 104 updates the BIG configuration data 125 to produce updated BIG configuration data 320. As an example, broadcast circuitry 104 updates BIG configuration data 125 to define a broadcast event as having a single non-control subevent.

After updating the BIG configuration data 125 based on the predetermined values for BIG configuration parameters associated with the pause state 185, at block 420, UE 102 broadcasts an update packet that includes configuration update data 322 that reflects the updates made to the BIG configuration data 125 of the UE 102 to produce updated BIG configuration data 320. In embodiments, UE 102 broadcasts this update packet such that the broadcast update packet 326 is receivable by the receiver devices 112 in a BIG 118. In response to receiving the broadcast update packet 326, a receiver device 112 is configured to update the BIG configuration data 195 stored at the receiver device 112 based on the configuration update data 322 indicated by the broadcast update packet 326 so as to produce updated BIG configuration data 324. As an example, the receiver device 112 updates the BIG configuration data 195 at the receiver device 112 to match one or more values for BIG configuration parameters indicated in the configuration update data 322. In embodiments, the receiver devices 112 updates the BIG configuration data 195 such that the resulting updated BIG configuration data 324 defines a broadcast event as having a single non-control subevent. Further, in response to updating the BIG configuration data 125 based on the predetermined values for parameters associated with the pause state 185, at block 425, UE 102 is configured to broadcast null data based on the updated BIG configuration data 320. For example, during a broadcast event, UE 102 broadcasts one or more null data units during a single non-control subevent.

In some embodiments, certain aspects of the techniques described above may be implemented by one or more processors of a processing system executing software. The software comprises one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM) or other non-volatile memory device or devices, and the like. The executable instructions stored on the non-transitory computer-readable storage medium may be in source code, assembly language code, object code, or other instruction format that is interpreted or otherwise executable by one or more processors.

A computer-readable storage medium may include any storage medium, or combination of storage media, accessible by a computer system during use to provide instructions and/or data to the computer system. Such storage media can include but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A user equipment (UE), comprising:
media control circuitry configured to determine an audio stream is to enter a pause state; and
broadcast circuitry configured to:
broadcast one or more packets of the audio stream as a series of broadcast events defined by first broadcast isochronous group (BIG) configuration data;
in response to the audio stream entering the pause state, update the first BIG configuration data based on one or more predetermined values for BIG configuration parameters associated with the pause state to produce second BIG configuration data; and
broadcast one or more null data units in a broadcast event based on the second BIG configuration data.

2. The UE of claim 1, wherein the broadcast circuitry is configured to:
update the first BIG configuration data such that the second BIG configuration data defines a broadcast event as including two non-control subevents with a first non-control subevent of the two non-control subevents representing an anchor point of the broadcast event and a second non-control subevent of the two non-control subevents representing a synchronization point of the broadcast event.

3. The UE of claim 2, wherein the second BIG configuration data indicates a period of time between the first non-control subevent and the second non-control subevent.

4. The UE of claim 1, wherein the broadcast circuitry is configured to:
in response to updating the first BIG configuration, broadcast an update packet associated with the second BIG configuration data.

5. The UE of claim 1, wherein the broadcast circuitry is configured to:
update the first BIG configuration data such that the second BIG configuration data defines a broadcast event as including one non-control subevent.

6. The UE of claim 1, wherein:
the media control circuitry is configured to determine the audio stream is to enter a play state; and
the broadcast circuitry is configured to, in response to the audio stream entering the pause state, modify the second BIG configuration data based on one or more predetermined values for BIG configuration parameters associated with the play state to produce third BIG configuration data.

7. The UE of claim 6, wherein the broadcast circuitry is configured to:
in response to modifying modify the second BIG configuration data, broadcast an update packet based on the third BIG configuration data.

8. The UE of claim 1, wherein the first BIG configuration data indicates a number of subevents and a burst number for a broadcast event of the series of broadcast events.

9. The UE of claim 1, wherein the broadcast circuitry is configured to broadcast the one or more packets of the audio stream such that the one or more packets are receivable by a plurality of receiver devices in a BIG.

10. The UE of claim 9, wherein a receiver device of the plurality of receiver devices includes BIG configuration data indicating a synchronization point associated with a broadcast event of the series of broadcast events.

11. A user equipment (UE), comprising:
media control circuitry configured to determine an audio stream is to enter a pause state; and
broadcast circuitry configured to:
broadcast one or more packets of the audio stream as a series of broadcast events defined by first broadcast isochronous group (BIG) configuration data;
in response to the audio stream entering the pause state, update the first BIG configuration data based on one or more predetermined values for BIG configuration parameters associated with the pause state to produce second BIG configuration data;
broadcast an update packet representing the second BIG configuration data; and
broadcast one or more null data units in a broadcast event based on the second BIG configuration data.

12. A method, comprising:
broadcasting, by a user equipment (UE), one or more packets of an audio stream as a series of broadcast events defined by first broadcast isochronous group (BIG) configuration data;
in response to the audio stream entering a pause state, updating the first BIG configuration data based on one or more predetermined values for BIG configuration parameters associated with the pause state to produce second BIG configuration data; and
broadcasting, by the UE, one or more null data units in a broadcast event based on the second BIG configuration data.
